(19) United States
(12) Patent Application Publication
(10) Pub. No.: US 2004/0046341 A1
(43) Pub. Date: Mar. 11, 2004

(54) Shopping cart having caster lift

(75) Inventor: Richard Wilkinson, Broken Arrow, OK (US)

Correspondence Address: WOOD, PHILLIPS, KATZ, CLARK & MORTIMER, 500 W. MADISON STREET, SUITE 3800, CHICAGO, IL, 60661, US

(73) Assignee: Unarco Industries, Inc.

(21) Appl. No.: 10/235,736

(22) Filed: Sep. 5, 2002

(51) Int. Cl. B62D 39/00

(52) U.S. Cl. 280/33.991

(57) ABSTRACT

A shopping cart, which is nestable into a preceding, similarly constructed cart and into which a following, similarly constructed cart is nestable, comprises a chassis having front and rear casters, having a transversely extending bar, and having similarly shaped, transversely spaced, camming elements,

wherein the camming structure of the shopping cart is adapted to cam the transversely extending structure of a preceding, similarly constructed cart, into which the shopping cart is being nested, upwardly so as to elevate the rear casters of the preceding, similarly constructed cart, and

wherein the transversely extending structure of the shopping cart is adapted to be cammed upwardly by the camming structure of a following, similarly constructed cart, which is being nested into the shopping cart, so as to elevate the rear casters of the shopping cart.

### TECHNICAL FIELD OF THE INVENTION

This invention pertains to a shopping cart, which is nestable into a preceding, similarly constructed cart and into which a following, similarly constructed cart is nestable. This invention provides the shopping cart with a rear caster-lifting capability, which reduces wear and damage to rear casters of the shopping cart.

### BACKGROUND OF THE INVENTION

Conventionally, a shopping cart is designed to be nestable into a preceding, similarly constructed cart and to enable a following, similarly constructed cart to be nested into the shopping cart. Commonly, in retail stores and in parking areas near retail stores, long lines of nested shopping carts may be formed, which must be moved by store personnel.

Typically, a rear caster comprises a horn, which unlike the horn of a front caster does not swivel and which mounts an axle, and a wheel, which is journalled on the axle, via a bearing, and which has a tread. Moving of a line of nested shopping carts stresses rear casters of the nested carts, tends to cause the horns of said casters to bend, and tends to cause the bearings and treads of said casters to wear excessively, particularly as attempts are made to turn the line of nested shopping carts.

### SUMMARY OF THE INVENTION

This invention provides a shopping cart, which is nestable into a preceding, similarly constructed cart and into which a following, similarly constructed cart is nestable, wherein the shopping cart comprises a chassis, which has front and rear casters including two rear, transversely spaced casters, which has a transversely extending structure, and which has a camming structure. The camming structure of the shopping cart is adapted to cam the transversely extending structure of a preceding, similarly constructed cart, into which the shopping cart is being nested, upwardly so as to elevate the rear casters of the preceding, similarly constructed cart. The transversely extending structure of the shopping cart is adapted to be cammed upwardly by the camming structure of a following, similarly constructed cart, which is being nested into the shopping cart, so as to elevate the rear casters of the shopping cart.

Preferably, the camming structure of the shopping cart defines an upper, generally horizontal platform, on which the transversely extending structure of a preceding, similarly constructed cart can be seated after having been cammed upwardly. Preferably, the camming structure comprises similarly shaped, transversely spaced, camming elements. Preferably, each camming element of the shopping cart defines an upper, generally horizontal platform, on which the transversely extending structure of a preceding, similarly constructed cart can be seated after having been cammed upwardly. Preferably, the transversely extending structure of the shopping cart comprises a bar, which extends across the chassis of the shopping cart.

### BRIEF DESCRIPTION OF THE DRAWINGS

FIG. 1 is a longitudinal cross-section of a shopping cart standing on a horizontal surface and constituting a preferred embodiment of this invention.

FIG. 2 is a fragmentary, side elevation of lower structures of the shopping cart and of lower structures of a similar cart being nested into the shopping cart.

FIG. 3 is a fragmentary, side elevation of lower structures of the shopping cart and of lower structures of the similar cart after having been nested into the shopping cart.

FIG. 4, on an enlarged scale compared to FIGS. 1, 2, and 3, is a fragmentary, perspective detail of what is illustrated in FIG. 3, from a front, side vantage.

FIGS. 5, 6, and 7, on an enlarged scale compared to FIG. 4, are views of an exemplary one of two camming elements of the shopping cart, FIG. 5 being an upper plan, FIG. 6 being a side elevation, and FIG. 7 being a front elevation.

### DETAILED DESCRIPTION OF THE ILLUSTRATED EMBODIMENT

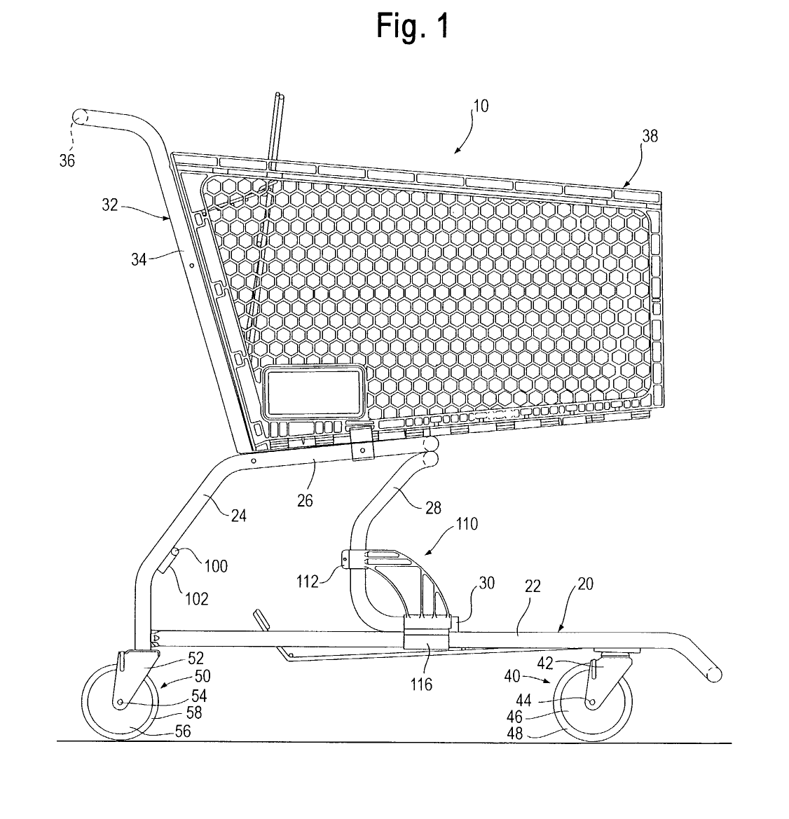

As illustrated in FIG. 1, a shopping cart 10 constituting a preferred embodiment of this invention is similar, except as disclosed herein, to the shopping cart disclosed in U.S. Pat. No. 5,791,666, the disclosure of which is incorporated herein by reference. The shopping cart 10 is illustrated as standing on an underlying surface S, such as a floor.

The shopping cart 10 comprises a chassis 20 having two longitudinally extending, tubular steel members 22, one along each side of the chassis 20, having two rear, tubular steel uprights 24, which are welded to the longitudinally extending members 22 and which extend frontwardly at the upper ends 26 of the rear uprights 24, and having two intermediate, tubular steel uprights 28, which are welded to the longitudinally extending members 22, at the lower ends 30 of the intermediate uprights 28, and to the rear uprights 24, at the upper ends 28 of the rear uprights 24. The shopping cart 10 comprises a handle assembly 32, which includes two generally vertically extending, transversely spaced, tubular steel uprights 34, a transverse handle 36, which extends between the handle uprights 34. The shopping cart 10 comprises a basket 38, which is mounted to the chassis 20 and to the handle assembly 32.

The chassis 20 has two front, transversely spaced casters 40, which are mounted to the chassis 20, and two rear, transversely spaced casters 50, which are mounted to the chassis 20. Each front caster 40 comprises a horn 42, which is adapted to swivel about a vertical axis, an axle 44, which is mounted operatively to the horn 42, and a wheel 46, which is journalled on the axle 44, via a bearing, and which has a tread 48. Each rear caster 50 comprises a horn 52, which is not adapted to swivel, an axle 54, which is mounted operatively to the horn 52, and a wheel 56, which is journalled on the axle 54, via a bearing, and which has a tread 58. The bearings of the casters 40, 50, are concealed in the drawings.

The chassis 20 has a transversely extending bar 100, which is welded at its opposite ends 102 to the rear uprights 24 so as to extend across the chassis 20. The chassis 20 has two similarly shaped, transversely spaced, camming elements 110, which are molded from a suitable engineering polymer, such as nylon 6, and which are mounted to the chassis 20 so as to be frontward of the transversely extending bar 100, about midway between the front casters 30 and the rear casters 40. Each camming element 110 has a rear, bifurcated end 112, which embraces one of the intermediate uprights 28 and which is drawn together by a fastener (not illustrated) passing through aligned holes 114 in said end 112. Each camming element 110 has a lower, bifurcated end 116, which is snapped over the lower ends 30 of the intermediate uprights 28 and over the longitudinally extending members 22 so as to cover welds between the lower ends 30 of the intermediate uprights 28 and the longitudinally extending members 22. Each camming element 110 has a convex, front edge 120 and a flat, upper edge 130.

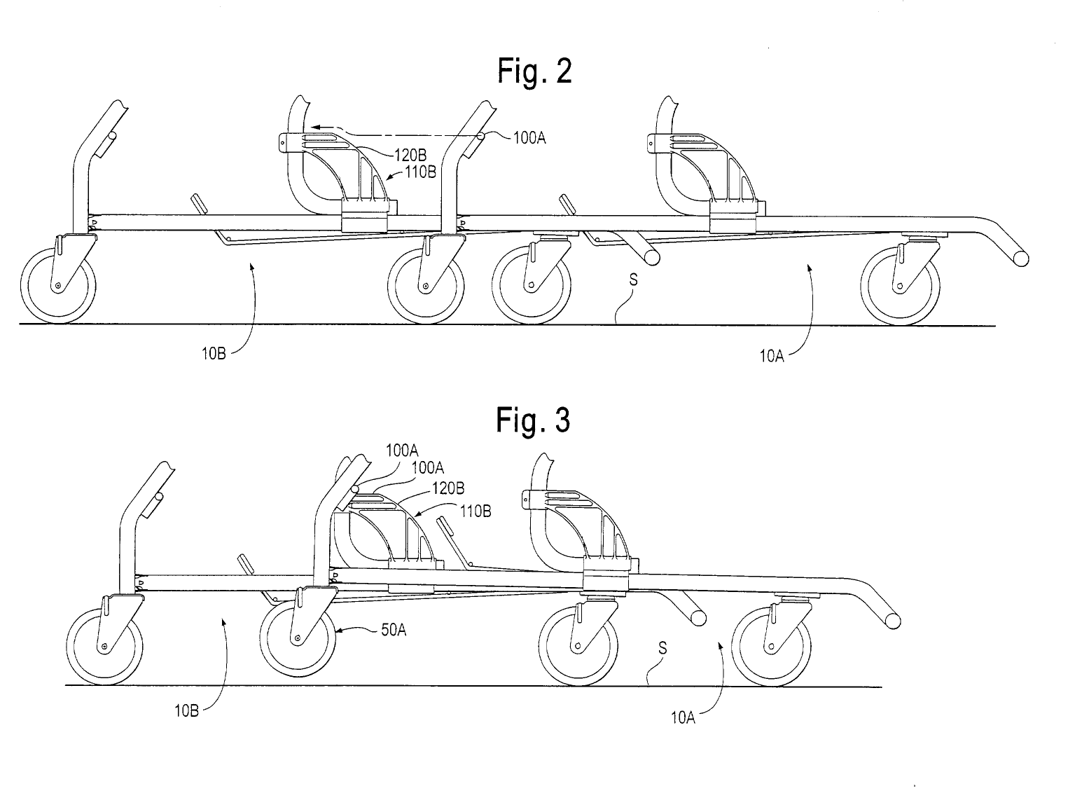

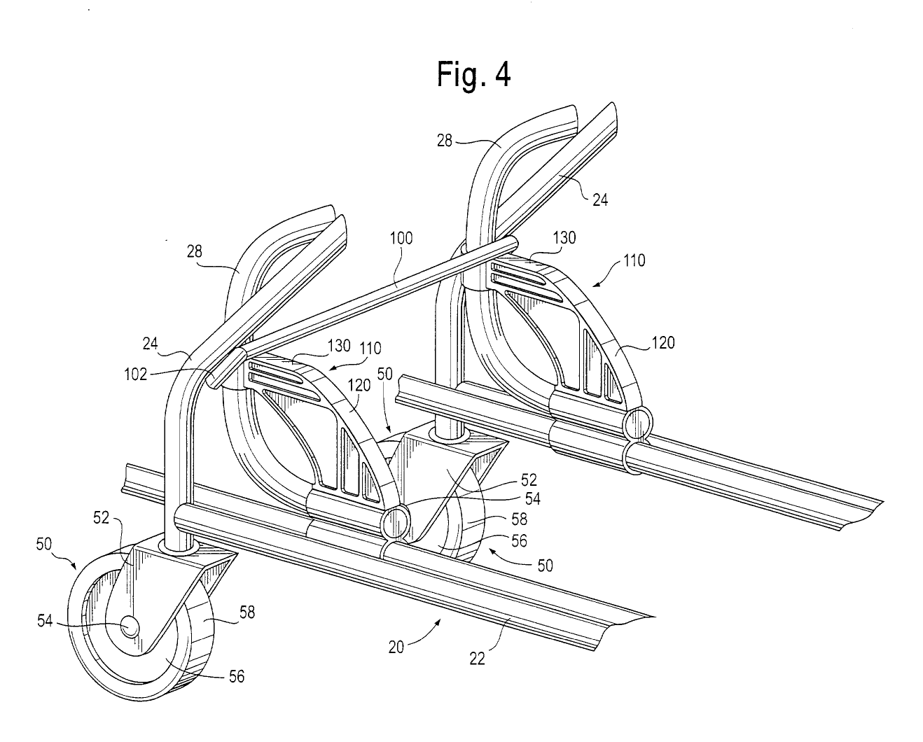

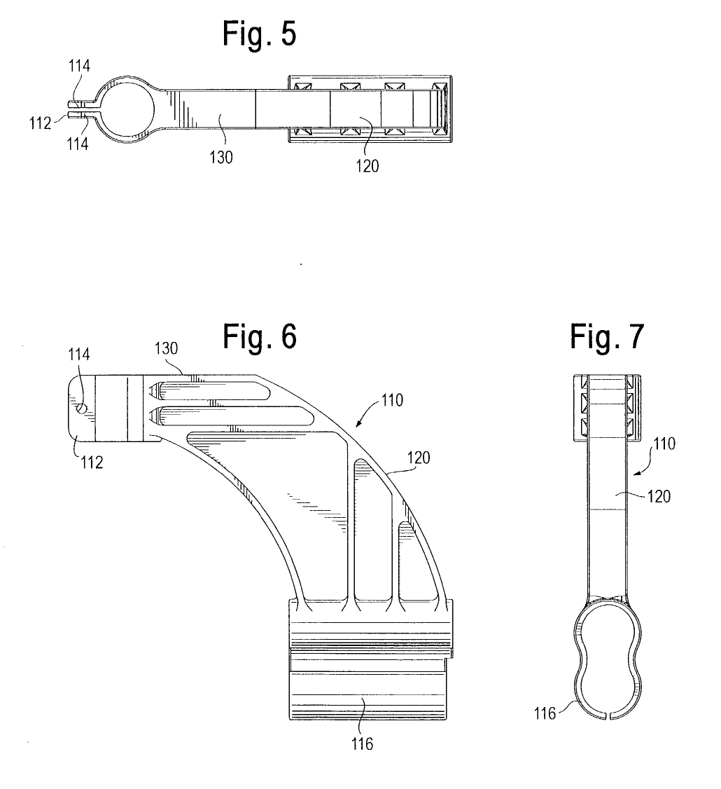

In connection with FIGS. 2 and 3, in which the chassis, casters, and other lower portions of two shopping carts are illustrated, each being constructed as the shopping cart 10 is constructed and each standing on the underlying surface S, it is convenient to refer to the right-hand cart as a preceding cart 10A and to refer to the left-hand cart as a following cart 10B. The preceding cart 10A has a transversely extending bar 100A, which is similar to the transversely extending bar 100 of the shopping cart 10, and the following cart 10B has two camming elements 110B, which are similar to the camming elements 110 of the shopping cart 10. The camming elements 110B are mounted on the intermediate uprights 28B, which are similar to the intermediate uprights 28 of the shopping cart 10. Each camming element 110B has a convex, front edge 120B and a flat, upper edge 130B. The preceding cart 10A has two rear casters 50A, which are similar to the rear casters 50 of the shopping cart 10.

As illustrated in FIGS. 2 and 3, the convex, front edges 120B of the camming elements 110B of the following cart 10B are adapted to cam the transversely extending bar 100A of the preceding cart 10A, into which the following cart 10B is being nested, upwardly so as to elevate the rear casters 40A of the preceding cart 10A above the underlying surface S. Moreover, the transversely extending bar 100A of the preceding cart 10 is adapted to be cammed upwardly by convex, front edges 120B of the camming elements 110B of the following cart 10B, which is being nested into the preceding cart 10A, so as to elevate the rear casters 40A of the preceding cart 10A. Furthermore, the flat, upper edges 130 130B of the camming elements 110 of the following cart 10B define an upper, generally horizontal platform, on which the transversely extending bar 100A of the preceding cart 10A can be seated after having been cammed upwardly. Nesting of the following cart 10B into the preceding cart 10A is limited by engagement of the transversely extending bar 10A of the preceding cart 10A with the intermediate uprights 28 of the following cart 10B.

The shopping carts 10A, 10B, exemplify any two nested carts in a long line of nested shopping carts. Because the rear casters of the nested carts are elevated above the underlying surface, except for the rear casters of the final cart in the line, moving of the line of nested shopping carts does not stress the elevated casters, does not tend to cause the horns of the elevated casters to bend, and does not tend to cause the bearings or treads of the elevated casters to wear excessively, particularly as attempts are made to turn the line of nested shopping carts. Because all casters touching the underlying surface can swivel, except for the rear casters of the final cart in the line, the line can be turned easily.

1. A shopping cart, which is nestable into a preceding, similarly constructed cart and into which a following, similarly constructed cart is nestable,
wherein the shopping cart comprises a chassis, which has front and rear casters including two rear, transversely spaced casters, which has a transversely extending structure, and which has a camming structure,
wherein the camming structure of the shopping cart is adapted to cam the transversely extending structure of a preceding, similarly constructed cart, into which the shopping cart is being nested, upwardly so as to elevate the rear casters of the preceding, similarly constructed cart, and
wherein the transversely extending structure of the shopping cart is adapted to be cammed upwardly by the camming structure of a following, similarly constructed cart, which is being nested into the shopping cart, so as to elevate the rear casters of the shopping cart.

2. The shopping cart of claim 1 wherein the camming structure of the shopping cart defines an upper, generally horizontal platform, on which the transversely extending structure of a preceding, similarly constructed cart can be seated after having been cammed upwardly.

3. The shopping cart of claim 1 wherein the camming structure comprises similarly shaped, transversely spaced, camming elements.

4. The shopping cart of claim 3 wherein each camming element of the shopping cart defines an upper, generally horizontal platform, on which the transversely extending structure of a preceding, similarly constructed cart can be seated after having been cammed upwardly.

5. The shopping cart of claim 1 wherein the transversely extending structure of the shopping cart comprises a bar, which extends across the chassis of the shopping cart.

6. The shopping cart of claim 2 wherein the transversely extending structure of the shopping cart comprises a bar, which extends across the chassis of the shopping cart.

7. The shopping cart of claim 3 wherein the transversely extending structure of the shopping cart comprises a bar, which extends across the chassis of the shopping cart.

8. The shopping cart of claim 4 wherein the transversely extending structure of the shopping cart comprises a bar, which extends across the chassis of the shopping cart.
